(19) United States
(12) Patent Application Publication
(10) Pub. No.: US 2025/0006394 A1
(43) Pub. Date: Jan. 2, 2025

(54) METHOD FOR THE PRODUCTION OF ISOTOPES WITH HIGH-ENERGY LASER PULSES ASSISTED BY PLASMONIC AMPLIFICATION

(71) Applicant: WIGNER FIZIKAI KUTATÓKÖZPONT, Budapest (HU)

(72) Inventors: Mark ALADI, Budapest (HU); Tamas Sandor BIRO, Piliscsaba (HU); Laszlo Pal CSERNAI, Budapest (HU); Miklos Akos KEDVES, Budapest (HU); Norbert KROO, Budapest (HU); Istvan RIGO, Bicske (HU); Miklos VERES, Biatorbagy (HU)

(21) Appl. No.: 18/708,692

(22) PCT Filed: Nov. 8, 2022
(86) PCT No.: PCT/HU2022/050080

§ 371 Date: May 9, 2024

(30) Foreign Application Priority Data
Nov. 9, 2021 (HU) P2100387

(51) Int. Cl. G21G 1/10; G21G 1/12

(52) U.S. Cl. CPC G21G 1/10; G21G 1/12

(57) ABSTRACT

A method for the production of isotopes with high-energy laser pulses assisted by plasmonic amplification, resulting in transmutation of nuclei, in particular hydrogen nuclei, of mass less than 6, characterized by plasmonic amplification of the laser field above a specific power density of at least 10¹³ W/cm², by the amplification achieved with the use of plasmonic metal or dielectric nanoparticles resonant to the wavelength of the applied laser field between 600 and 1100 nm, leading to the amplification of the electromagnetic field of the laser, which does not have the necessary intensity to initiate the reaction, locally above the threshold level by interacting with nanoparticles with plasmonic properties, or, in the case of an already running reaction, this plasmonic interaction can be used to increase the efficiency of the reaction.

### FIELD OF THE INVENTION

The invention relates to the field of energetics and transmutation with mass number change A->A+1. More specifically, the invention is related to a method for producing isotopes by irradiating a target with high-energy laser pulses involving plasmonic enhancement resulting in transmutation of nuclei of mass number less than 6, in particular hydrogen nuclei.

### BACKGROUND

Isotopes are used in many areas of modern technology, from energy production to medicine (e.g., positron emission tomography). A specific industry has been developed for the production and concentration of different isotopes, and the most common methods in this field are the production in reactors and particle accelerators, chemical separation and electromagnetic enrichment. The market for isotopes used in medicine was USD 17 billion in 2020 and is forecast to double by 2027.

U.S. Pat. No. 10,217,538 B2 describes a method for producing isotopes by laser irradiation, whereby a target is brought into a plasma state, and then it is bombarded with particles produced by laser irradiation, more specifically by a bundle of laser beams, so that the bundle of the laser beams is synchronized with the formation of the plasma state. The laser beam and the particles are chosen so that the plasma-state target and the particles undergo a nuclear reaction, and the produced isotopes are extracted. A shortcoming of the process is that it requires high intensity laser radiation to accelerate the particles.

### SUMMARY

It is recognized that the laser intensity required for the above procedure can be reduced, and the procedure will be more efficient at the same intensity, if the electromagnetic field of the laser is locally amplified by a factor of 10³-10⁴ using metallic nanoantennas.

The task has been solved by a method for the production of isotopes by irradiation of a target with high-energy laser pulses in the presence of plasmonic enhancement resulting in the transmutation of nuclei, in particular hydrogen nuclei, with mass numbers below 6, by realizing a laser field with plasmonic amplification above a specific power density of at least 10¹³ W/cm², where the amplification is achieved by plasmonic metal or dielectric nanoparticles being resonant to the wavelength of the applied laser field between 600 and 1100 nm.

According to a preferred embodiment of the method according to the invention, nanoparticles prepared from metals like gold, silver and copper are used as plasmonic metal nanoparticles.

According to a further advantageous embodiment of the method according to the invention, the target could be a solid or liquid target.

According to a further advantageous embodiment of the method according to the invention, nanoparticles of a shape of a sphere, rod, shell-core, or triangle are used.

According to a further preferred embodiment of the method according to the invention, the nanoparticles are selected such that their plasmon resonance wavelength or one of their plasmon resonance wavelengths is equal to the wavelength of the laser.

In accordance with a further advantageous embodiment of the method according to the invention, a laser intensity exceeding 10¹⁵ W/cm² is used.

### DETAILED DESCRIPTION

Our approach is to locally amplify the electromagnetic field of a laser having insufficient intensity to trigger a reaction above the threshold level by interacting it with nanoparticles with plasmonic properties, or to use this plasmonic interaction to increase the efficiency of an already running reaction.

The invention is described in more detail below with one possible embodiment of the proposed method. The method for producing isotopes includes an intense surface plasmonic field created by irradiation of plasmonic nanoparticles, such as gold nanoparticles, and their immediate surroundings up to the distance of a few tens of nanometers from their surface with high energy laser pulses. If hydrogen atoms are present in the surroundings of the nanoparticles, proton plasmons moving synchronously with this plasmonic field are excited, and the interaction of the two plasmonic fields increases the effective mass of the electrons, which are then able to fuse with the hydrogen nuclei and form neutrons. These neutrons are very slow (the absorption effective cross section can be as low as 10⁸ barn) and are absorbed by the material within a few atomic distances. If this material is hydrogen, this atom is converted into deuterium. The gamma rays produced in this process are scattered by the heavy electrons and converted into low-energy photons and heat. The process therefore does not result in radioactivity, only in transmutation and energy production. Although the described reaction, i.e., electron capture and neutron capture, is known, known methods do not use plasmonic amplification with metal nanoparticles, which is the main novel feature of the invention.

The electromagnetic field of an intense laser beam with a power density above 10¹³ W/cm² (preferably above 10¹⁵ W/cm²) can interact with electrically charged particles, i.e., electrons, protons, ions, and at high intensities of 10¹⁵ W/cm², even with electrically neutral atoms or molecules. These effects are more pronounced in laser beams consisting of synchronized photons, and are further multiplied in ultrashort pulsed lasers with pulse durations in the range of 10-100 fs, which concentrate the electromagnetic field into short light pulses. The average power of such a laser beam is not necessarily high (could be in the range of 1-10 W), but with a low repetition rate (in the range of 1-100 Hz) and a short pulse duration (in the range of 10-100 fs), this power can result in very high peak power (up to petawatts) concentrated in the pulses. These focused laser pulses with short pulse duration and high pulse intensities are used to generate plasma in a solid or liquid and/or gaseous target. In addition, the high electromagnetic field of the pulse (above 10¹⁵ W/m), accelerates the ions and electrons in the plasma to such an extent that they can collide and interact with each other by overcoming the Coulomb barrier, i.e., the electrical repulsion between particles with the same electric charge, and new isotopes are formed primarily because the Coulomb barrier is lowered due to the coherence of the plasmon wave, increasing the probability of the tunnelling effect by orders of magnitude.

For the practical application of the above method for isotope production, the laser power level required to trigger the nuclear reactions must be ensured in as large volume of the target as possible, i.e., the specific pulse energy per volume of the target must exceed the threshold level required to overcome the Coulomb barrier in as large volume as possible. One way of achieving this is to increase the laser power, which is known to the specialist from the relevant literature. Such a procedure can be found, for example, in the bibliography [1]-[4] at the end of this description.

Another possibility is to create conditions in the target that allow local amplification of the electromagnetic field of the laser pulse. Such a procedure can be found, for example, in the bibliography [5] and [6] at the end of this description.

One solution could be the use of novel plasmonic nanoparticles, in which a resonant oscillation of free electrons can be generated (determined by the gold, silver or copper material of the nanoparticles, the dielectric properties of the medium containing them, their size between 5-100 nm, and shape (spherical or rod-shaped with an aspect ratios between 1:1.5 and 1:10)) when coupled to the external electromagnetic field, significantly increasing the field strength in the immediate vicinity of the nanoparticle. By filling the target irradiated by the pulsed laser with such plasmonic nanoparticles, this local field strength increase can be generated in large spherical regions of up to 1 mm in diameter, covering the focal volume of the laser.

Based on the dielectric properties and frequency-dependent conductivity of the materials, plasmonic nanoparticles can be made primarily from gold, silver, copper, and their alloys. Each of these metals exhibits good plasmonic properties in different light wavelength regions, such as silver in the range 350-700 nm, gold in the range 500-800 nm, copper in the range 600-1100 nm, and their plasmon resonance frequencies are tunable over a wide wavelength range by changing the shape and size of the nanoparticles. For example, plasmonic gold nanospheres and/or nanorods of a few tens of nanometres in size exhibit resonance in the near-infrared wavelength region.

In an exemplary embodiment of the method according to the invention, gold nanoparticles embedded in an uracil dimethacrylate (UDMA) polymer were illuminated by femtosecond laser pulses at a wavelength of 800 nm. A comparative analysis of the irradiated and non-irradiated volumes of the polymer showed that the concentration of deuterium in the target increases, i.e., some of the hydrogen present is converted to deuterium as a result of nuclear reactions. This was not observed in the case of laser irradiations under the same conditions on a reference target without nanoparticles. This demonstrates that the use of plasmonic particles as invented allows the production of isotopes even at relatively low laser intensities, e.g., 10¹⁵ W/cm², by means of local field enhancement.

During laser pulse irradiation, craters are formed in the irradiated solid target consisting of a polymer with a high hydrogen content and being transparent at the wavelength of the laser used, such as UDMA, diethylene glycol dimethacrylate and other methacrylates, polyethylene terephthalate, acrylonitrile butadiene styrene and other polymers, and some of the material evaporates. After a while, this leads to a significant reduction in the efficiency, as no or very little material remains at the focal spot of the laser beam. Therefore, precision target movement should be performed to continuously produce isotopes, and continuous feedback on the efficiency of the irradiation is implemented. Precision target moving is implemented using precision motors and control systems such as Picard Industries 3D Stage, Thorlabs MT1, etc., but monitoring the efficiency of the irradiation is not straightforward because the environment of the focal spot having a size of a few tens of microns is difficult to monitor by imaging techniques. A possible solution to this problem is to measure the intensity of two-photon autofluorescence in the polymer. Two-photon excited fluorescence is a nonlinear optical process the probability and hence the intensity of which depends on the wavelength, intensity, pulse characteristics of the excitation beam, and mainly on the photon density, which is, in case of a correctly positioned target, will be the highest in the focal volume. In the case of misfocusing, presence of large craters formed during previous irradiation or other suboptimal conditions, the two-photon emission intensity will decrease, so its measurement can be used as feedback on the correct positioning of the target.

Instead of a solid target, it is also possible to use a liquid target. Here, the local inhomogeneities caused by laser-induced plasma formation and local evaporation are eliminated in a very short time by the nature of the liquid, so that the target does not need to be moved for further irradiation. Suitable gold nanoparticles in the size range of 25×70 nm to 25×100 nm and with a suitable concentration of 10¹²-10¹⁶ nanoparticles/cm³ in suspension or colloidal form can be easily prepared by known methods and delivered to the irradiation site, ensuring a continuous supply.

Among the advantages of the method according to the invention, it can be mentioned that it can be widely used due to the wide range of different isotopes. It allows certain isotopes to be produced at the point of use and immediately prior to use, which can significantly reduce production and storage costs.

### BIBLIOGRAPHY

[1] Yasunobu ARIKAWA, Masaru UTSUGI, Morace ALESSIO, Takahiro NAGAI, Yuki ABE, Sadaoki KOJIMA, Shohei SAKATA, Hiroaki INOUE, Shinsuke FUJIOKA, Zhe ZHANG, Hui CHEN, Jaebum PARK, Jackson WILLIAMS, Taichi MORITA, Yoichi SAKAWA, Yoshiki NAKATA, Junji KAWANAKA, Takahisa JITSUNO, Nobuhiko SARUKURA, Noriaki MIYANAGA, Mitsuo NAKAI, Hiroyuki SHIRAGA, Hiroaki NISHIMURA, Hiroshi AZECHI, High-Intensity Neutron Generation via Laser-Driven Photonuclear Reaction, Plasma and Fusion Research, 2015, Volume 10, Pages 2404003, Released Jan. 18, 2017, Online ISSN 1880-6821, https://doi.org/10.1585/pfr.10.2404003,
[2] S. A. Reed, V. Chvykov, G. Kalintchenko, T. Matsuoka, P. Rousseau, and V. Yanovsky, C. R. Vane, J. R. Beene, D. Stracener, and D. R. Schultz, A. Maksimchuk, “Photonuclear fission with quasimonoenergetic electron beams from laser wakefields”, Appl. Phys. Lett. 89, 231107 (2006) https://doi.Org/10.1063/1.2400400
[3] K. W. D. Ledingham, I. Spencer, T. McCanny, R. P. Singhal, M. I. K. Santala, E. Clark, I. Watts, F. N. Beg, M. Zepf, K. Krushelnick, M. Tatarakis, A. E. Dangor, P. A. Norreys, R. Allott, D. Neely, R. J. Clark, A. C. Machacek, J. S. Wark, A. J. Cresswell, D. C. W. Sanderson, and J. Magill, Photonuclear Physics when a Multiterawatt Laser Pulse Interacts with Solid Targets, Phys. Rev. Lett. 84, 899, 2000
[4] Turinge, A. A., Nedorezov, V. G. & Saveliev, A. B. Study of Photonuclear Reactions near the Threshold at an Electron Accelerator and a Femtosecond Laser. Phys. Part. Nuclei 49, 569-575 (2018). https://doi.arg/10.1134/S1063779618040548
[5] Csernai, L., Kroo, N., & Papp, I. (2018). Radiation dominated implosion with nano-plasmonics. Laser and Particle Beams, 36(2), 171-178. doi:10.1017/S0263034618000149
[6] Csernai, L. P., Csete, M., Mishustin, L N. et al. Radiation-Dominated Implosion with Flat Target. Phys. Wave Phen. 28, 187-199 (2020). https://doi.org/10.3103/S1541308X20030048

1-6. (canceled)

7. A method comprising:
producing isotopes with high-energy laser pulses assisted by plasmonic amplification, causing transmutation of atoms of less than 6 mass number, in particular hydrogen atoms, wherein plasmonic amplification of the local laser field is above a specific power density of at least 10¹³ w/cm², and wherein the amplification is achieved by plasmonic metal or dielectric nanoparticles resonant to the wavelength of the applied laser field between 600 and 1100 nm.

8. The method according to claim 7 wherein the plasmonic metal nanoparticles are selected from the group consisting of gold, silver, and copper.

9. The method according to claim 7 wherein producing comprising producing isotopes with high-energy laser pulses using a solid target.

10. The method according to claim 7 wherein the nanoparticles comprise at least one of spherical, rod, shellcore, or triangular shaped nanoparticles.

11. The method according to claim 7 wherein at least one plasmon resonance wavelength of the nanoparticles is equal to the wavelength of the applied laser field.

12. The method according to claim 7 wherein producing comprises producing isotopes using laser intensities exceeding 10¹⁵ W/cm².

13. The method according to claim 7 wherein producing comprises producing isotopes with high-energy laser pulses using a liquid target.

14. A method comprising:
producing isotopes with high-energy laser pulses assisted by plasmonic amplification, causing transmutation of atoms of less than 6 mass number, wherein plasmonic amplification of the local laser field is above a specific power density of at least 10¹³ W/cm², and wherein the amplification is achieved by plasmonic nanoparticles resonant to the wavelength of the applied laser field between 600 and 1100 nm.

15. The method according to claim 14 wherein the plamonic nanoparticles comprise plasmonic metal nanoparticles.

16. The method according to claim 15 wherein the plasmonic nanoparticles comprise at least one of gold, silver, and copper.

17. The method according to claim 14 wherein producing comprises producing isotopes with high-energy laser pulses using a solid target.

18. The method according to claim 14 wherein producing comprises producing isotopes with high-energy laser pulses using a liquid target.

19. The method according to claim 14 wherein the nanoparticles comprise at least one of spherical, rod, shellcore, or triangular shaped nanoparticles.

20. The method according to claim 14 wherein at least one plasmon resonance wavelength of the nanoparticles is equal to the wavelength of the applied laser field.

21. The method according to claim 14 wherein producing comprises producing isotopes using laser intensities exceeding 10¹⁵ W/cm².
